(19) United States
(12) Patent Application Publication
(10) Pub. No.: US 2008/0122135 A1
(43) Pub. Date: May 29, 2008

(54) PRODUCTION PROCESS OF EMBOSSED RESIN SHEET MATERIAL

(75) Inventors: Hisanori OKU, Niihama-shi (JP); Hironobu IYAMA, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/943,676

(22) Filed: Nov. 21, 2007

(30) Foreign Application Priority Data
Nov. 29, 2006 (JP) P2006-321461

(51) Int. Cl. B28B 3/20; B29C 53/00

(52) U.S. Cl. 264/176.1; 425/324.1

(57) ABSTRACT

There is provided a process for the production of an embossed sheet material for the purpose of improving a embossing accuracy.
The process comprises the steps of:
providing a continuous resin sheet material by extruding a molten resin through a die, and
imprinting a surface profile of an embossing member by nipping the continuous resin sheet material between a press roll and the embossing member
wherein the embossing member is made of an organic material.

### CROSS-REFERENCE TO RELATED APPLICATION

The present application claims a priority of Japanese Patent Application No. 2006-321461 filed on Nov. 29, 2006 under the Paris Convention, and all contents of such application are incorporated herein by reference in their entirety.

### BACKGROUND OF THE INVENTION

1. Field of the Invention

The present invention relates to a process for the production of an embossed resin sheet material, and particularly to a process for the production of an embossed resin sheet material having an embossed surface which has a surface profile complementarily corresponding to a surface profile of an embossing member.

2. Description of the Related Art

Japanese Patent Unexamined Publication No. 1997-11328 discloses a process for the production of an embossed resin sheet material as shown in FIG. 1 wherein a resin (2) in its molten state is extruded through a die (3) to form a continuous resin sheet material (4), and then thus extruded sheet material (4) is pressed by and between a press roll (5) and an embossing member (6) so as to produce the embossed resin sheet material (1) which has an embossed surface having a surface profile complementarily corresponding to a surface profile of the embossing member by transferring the surface profile of the embossing member (6) to the extruded sheet material (4). There is no description in the Publication as to the material of which the embossing member (6) is made. A metal cylinder (6) fitted around a rotatable roll (7) or a meta rotatablel roll (7) having an engraved surface is generally used as the embossing member (6).

### SUMMARY OF THE INVENTION

The above explained process requires a transfer speed of the embossing member (6) to be reduced so as to transfer the surface profile of the embossing member (6) to the continuous resin sheet (4) with a high transfer accuracy, and therefore such process is not necessarily so productive.

It is therefore an object of the present invention to provide a process for the production of a resin sheet material having an embossed surface which complementarily corresponds to a surface profile of an embossing member with an improved accuracy and also an improved transfer speed of the embossing member. The present inventors carried out intensive studies on such an object, and have completed the following present inventions.

In the first aspect, the present invention provides a process for the production of an embossed sheet material comprising the steps of:

providing a continuous resin sheet material by continuously extruding a molten resin through a die, and

transferring (or imprinting) a surface profile of an embossing member by pressing (or nipping) the continuous resin sheet material by and between a press roll and the embossing member so as to produce the embossed resin sheet material,

wherein the embossing member is comprised (or made) of an organic material.

In the second aspect, the present invention provides an apparatus for the production of an embossed sheet material comprising

a die which provides with a continuous resin sheet material by extruding a molten resin, and

an embossing member of which surface profile is to be transferred to the continuous resin sheet material,

wherein the embossing member is made of an organic material.

In the present invention, the resin sheet material is continuous, but the term “continuous resin sheet material” does not exclude a resin sheet material which has a limited a length (usually a long length), which means that the sheet material is substantially continuous. Thus, in this context, the term “the continuous resin sheet material” of the present invention covers also “substantially continuous resin sheet material.”

According to the process of the present invention, the aimed embossed sheet material is produced more productively with a quicker speed as well as an improved accuracy of the surface profile transfer of the embossing member to the resin sheet material.

### BRIEF DESCRIPTION OF THE DRAWINGS

FIG. 1 schematically shows one example of a process for the production of an embossed resin sheet.

FIG. 2 schematically shows another example of a process for the production of an embossed resin sheet.

FIG. 3 schematically shows a further example of a process for the production of an embossed resin sheet.

In the drawings, reference numbers indicates the following members:
1: embossed resin sheet material, 2: resin, 3: die,
4: continuous resin sheet material, 5: press roll,
6: embossing member or organic material film,
7: rotatable roll, 8: extruder,
10: apparatus for embossed sheet material production,
51: first press roll, 52: second press roll

### DETAILED DESCRIPTION OF THE PREFERRED EMBODIMENTS

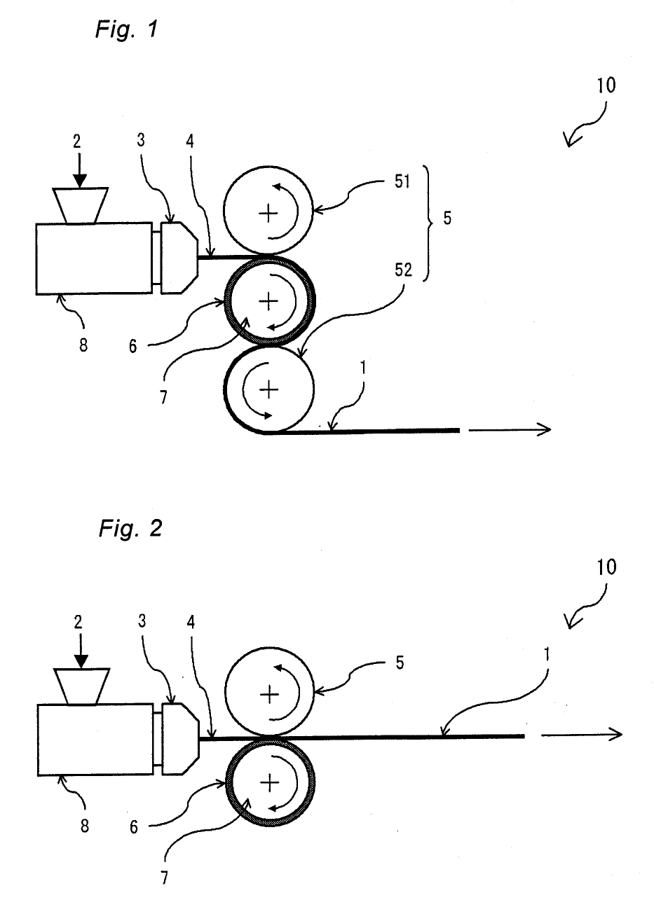

The present inventions will be described with reference to the accompanied drawings. Each of FIGS. 1 to 3 schematically shows an apparatus (10) which is used according to the present invention for the production of an embossed resin sheet material (1), and such apparatus comprises a die (3) through which a heated resin (2) in its molten state is continuously extruded so as to produce a continuous resin sheet resin material (4), a press roll(s) (5), and an embossing member (6) which presses the continuous sheet (4) together with the press roll (5) while the resin sheet is sandwiched by the embossing member (6) and the press roll (5).

The resin (2) which is used in the present invention is generally a thermoplastic resin which is melted when heated, but it may be a thermosetting resin which cures when heated. In particular, a styrene based resin, an acrylic resin, a polyethylene resin, a polypropylene resin, a cyclic based olefin polymer resin, an acrylonitrile-butadiene-styrene copolymer (ABS) resin, a polyethylene terephthalate (PET) resin, polycarbonate (PC) resin and so on are exemplified as the resin which is used in the present invention.

The resin (2) may contain an additive(s) such as a light diffusion agent, a UV absorber, a thermal stabilizer, an antistatic agent and so on.

The light diffusion agent may be an inorganic one or an organic one.

As the inorganic light diffusion agent, particles are exemplified which are made of an inorganic compound such as calcium carbonate, barium sulfate, titanium oxide, aluminum hydroxide, silica, inorganic glass, talc, mica, white carbon, magnesium oxide, zinc oxide or the like. The inorganic light diffusion agent may be subjected to a surface treatment with a surface treatment agent such as an aliphatic acid.

As the organic light diffusion agent, the following organic compound particles are exemplified: a styrene based polymer particles, a acrylic based polymer particles, a siloxane based polymer particles or the like. Further, the following particles are preferably used: high molecular weight polymer particles of which weight-average molecular weight is from 500,000 to 5,000,000, cross-linked polymer particles of which gel content as an insoluble component is not smaller than 10% by mass when the particles are dissolved into acetone, and the like.

When the light diffusion agent is added to the resin, an absolute figure of a difference between a refractive index of the light diffusion agent to be added and a refractive index of the resin (2) is usually not smaller than 0.2 from a viewpoint of the effect as to the light diffusion, and also usually not larger than 0.13 from a viewpoint of a light permeability of the embossed resin sheet material (1) to be produced.

The embossed sheet material (1) which is produced while using the resin (2) which contains the added light diffusion agent may be used as a light diffusion plate or a light diffusion film.

As the die (3), for example a T-die made of a metal may be used as in the conventional extrusion process.

An extruder (8) is used for extruding the resin (2) through the die (3) while being melted as in the conventional extrusion process. The extruder (8) may be a monoaxial extruder or a biaxial extruder. The resin (2) is heated in the extruder (8) and thus heated resin is sent to the die (3) in its molten state followed by being extruded through the die (3).

Upon the extrusion of the resin (2) through the die (3), one kind of the resin (2) may be supplied to the die (3) to form a single resin layer, or two or more kinds of the resins (2) may be supplied for coextruding them in a laminate structure. In order that the resins are coextruded into the laminate structure, a feed block for two-kind/three-layer distribution (not shown) is used, through which the resins are supplied to the die (3).

The resin (2) is extruded through the die (3) to be a continuous resin sheet material (4).

The extruded continuous resin sheet material (4) is sandwiched by the press roll (5) and the embossing member (6). As the press roll (5), usually a roll made of a metal such as a stainless steel, a steel or the like is used, and its diameter is usually in the range between 100 mm and 500 mm. When a metal roll is used as the press roll (5), it may have a plated surface formed with for example, chromium plating, copper plating, nickel plating, nickel-phosphorous plating or the like. A surface of the press roll (5) may be mirror finished or a roll having an embossed surface having irregularities thereon if not so good transfer accuracy is acceptable.

The embossing roll (6) presses a surface of the extruded continuous resin sheet material (4), so that its profile surface is transferred to the sheet material as an inverse surface profile which is complementary to the surface profile of the embossing member.

In the production process according to the present invention, the embossing member is comprised of (or made of) an organic material. The organic material has such thermal resistance that the embossing member (6) is able to keep its form even when the embossing member is repeatedly pressed onto the extruded continuous resin sheet material (4) which is in its condition just after the extrusion of the molten resin through the die (3). For example, a resin such as a thermosetting resin, a thermoplastic resin or the like may be used as the organic material.

As the thermosetting resin, for example a phenol resin, an epoxy resin, a melamine resin, a urea resin, a polyimide resin (Pl resin), an unsaturated polyester resin, an alkyd resin and the like are exemplified.

As the thermoplastic resin, for example a styrene based resin, an acrylic based resin, a polyethylene resin, a polypropylene resin, a cyclic olefin polymer resin, an acrylonitrile-butadiene-styrene resin (ABS resin), a polyethylene terephthalate resin (PET resin), a polycarbonate resin (PC resin), a polyether sulphone resin (PES resin), a thermoplastic polyimide resin (Pi resin) and the like are exemplified. Preferably, a thermoplastic resin, a cross-linked thermoplastic resin or the like of which Vicat softening temperature (according to JIS K7206-1999 A50) is higher than that of the resin (2) which is to be extruded through the die (3) by at least 40° C.

As the embossing member (6), a film member (6) made of the organic material which has a surface profile which is complementary to the aimed surface profile to be formed on the extruded sheet material. A thickness of the organic material film member is usually in the range between 0.1 mm and 5 mm.

For example, in one embodiment, such organic material film may be used as the embossing member (6) in its wound form around a rotatable roll (7) as shown in FIG. 1. In this embodiment, the press roll (5) may comprise two rolls of a first press roll (51) and a second press roll (52) as shown in FIG. 1. When the two press rolls (51, 52) are used, the extruded continuous resin sheet material (4) is generally first pressed by and between the first press roll (51) and the embossing member (6), then wound around the embossing member (6), and then pressed by and between the embossing roll (6) and the second press roll (52) as shown in FIG. 1. In other embodiment, the press roll (5) may be a single roll as shown in FIG. 2.

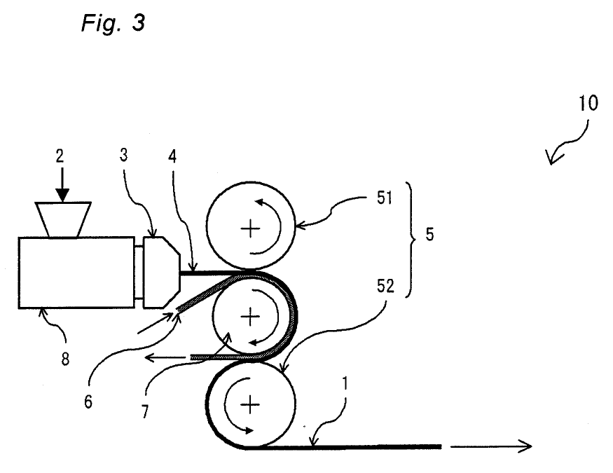

In a further embodiment, the organic material film (6) may be used as it is as the embossing member (6) for example as shown in FIG. 3. In this embodiment, the extruded continuous resin sheet material (4) is stacked on the organic material film (6), and they are pressed between and by the press roll (5) and the rotatable roll (7) so as to transfer the surface profile of the organic material film (6) to the extruded sheet material (4). After the transfer to the extruded continuous resin sheet material, the organic material film is usually rewound around a roll (not shown).

The surface profile of the embossing member (6) may b, for example, a profile having a many grooves which are formed parallel with each other and of which cross sections are V-shaped. A vertex angle of the V-shaped cross section is usually 160° or less, and 40° or more from a viewpoint of its easy formation. A depth of the groove (H) is usually 500 μm or less, and 10 μm or more from a viewpoint of the easy formation. A pitch of the V-shaped grooves is usually 10p m or more, and preferably 50 μm or more. The production process according to the present invention is preferable to the depth of the V-shaped groove having a depth of 10 μm or more and a pitch of 500 μm or less.

By transferring the surface profile of the embossing member (6) to the extruded continuous resin sheet material (4), the aimed embossed sheet material (1) is produced. Thus produced embossed continuous resin sheet material (1) is usually cut into leaf forms after it is further cooled, and for example they are used as prism sheets for the formation of the liquid crystal displays. When the resin including the light diffusion agent is used as the resin (2), the produced sheet material may be used as a light diffusing plate which has the transferred profile.

### EXAMPLES

The present invention will hereinafter be described in detail with reference to the following Example 1 and Comparative Example 1, but the present invention is not limited to Example 1.

### Example 1

[Production of Master Batch of Light Diffusion Agent]

Styrene resin pellets (52 parts by mass, “HRM40 ” manufactured by Toyo Styrene Co. Ltd., refractive index: 1.59, Vicat softening temperature: 106.8° C.), siloxane based polymer particles (4.0 parts by mass, cross-linked polymer particles, “Torayfil DY33-719” manufactured by Dow Corning Toray Co. Ltd., refractive index: 1.42, mean volume diameter: 2 μm), a UV absorber (2 parts by mass, “Sumisorb 200” manufactured by Sumitomo Chemical Co. Ltd., powder form), and a thermal stabilizer (2.0 parts by mass, “Sumiriser GP” manufactured by Sumitomo Chemical Co., Ltd., powder form) were dry blended, and then supplied to a biaxial extruder having a screw diameter of 65 mm through a hopper. In the extruder, the above mentioned components were heated to melt while kneading at 250° C. followed by extruding into strands, which were cut into pellet so that a master batch (pellet form) for the light diffusion agent was obtained. It is noted that the resin temperature in the extruder was 200° C. near the hopper, and the resin was heated to 250° C. for the extrusion.

[Production of Resin for Surface Layer]

A styrene-methyl methacrylate copolymer resin (75.8 parts by mass, “MS 200 NT” manufactured by Nippon Steel Chemical Co. Ltd., styrene unit: 80% by mass and methyl methacrylate unit: 20% by mass, refractive index: 1.57, pellet form, Vicat softening temperature: 102.1° C.), an acrylic based copolymer particles (23 parts by mass, cross-linked polymer particles, “Sumipex XCLA” manufactured by Sumitomo Chemical Co. Ltd., refractive index: 1.49, mean volume diameter: 25 μm), a UV absorber (1 part by mass, “LA-31” manufactured by Adeka Corporation, powder form), and a thermal stabilizer (0.2 parts by mass, “Sumirizer GP” manufactured by Sumitomo Chemical Co. Ltd., powder form) were dry blended, and then supplied to a biaxial extruder having a screw diameter of 65 mm through a hopper. In the extruder, the above mentioned components were heated to melt while kneading at 250° C. followed by extruding into strands, which were cut into pellet so that a resin (pellet form) for the surface layer was obtained. It is noted that the resin temperature in the extruder was 200° C. near the hopper, and the resin was heated to 250° C. for the extrusion.

[Production of embossed Sheet Material]

A resin for an intermediate layer and the resin for surface layer (2) were supplied to a feed distribution block for a two-kind three-layer structure (manufactured by Tanabe Plastic), and then transported to a T-die (3) so as to coextrude them, whereby the resin for the intermediate layer formed the intermediate layer and the resin for the surface layer formed the surface layers each of which was laminated on each surface of the intermediate layer, so that a continuous resin sheet material (4) having a three layer structure was produced.

The resin for the intermediate layer was supplied to the above described feed distribution block for the two-kind three-layer structure at a temperature of 250° C. after dry blending styrene resin pellets (97 parts by mass, “HRM 40” manufactured by Toyo Styrene Co., Ltd., refractive index: 1.59) and the above described master batch of the light diffusion agent (3 parts by mass), followed by supplying to a vent equipped monoaxial extruder (8) (manufactured by Tanabe Plastic) having a screw diameter of 40 mm so as to heat and melt them. The resin for the surface layer was supplied to the above described feed distribution block for the two-kind three-layer structure at a temperature of 250° C. after supplying the above described resin for the surface layer as it is to a vent equipped monoaxial extruder (8) (manufactured by Tanabe Plastic) having a screw diameter of 20 mm so as to heat and melt the resin. The T-die (3) had a width of 250 mm and a lip spacing of 2 mm. The produced continuous resin sheet material (4) had a width of 243 mm and a thickness of 1.5 mm.

As shown in FIG. 1, the continuous resin sheet material (4) coextruded through the T-die (3) was continuously supplied to a spacing between the first press roll (51) and the organic material film (6) as an embossing member which is located around the metal rotatable roll (7) so as to press the sheet material between them, and then pressed between such embossing member (6) and the second roll (52) while the sheet material is located around the embossing member (6), so that a surface profile of the embossing member (6) was transferred to the surface of the continuous resin sheet member (4), whereby the embossed sheet material (1) was produced. During such production, a production speed of the embossed sheet material (1) was 0.68 m/min.

It is noted that the organic material film as the embossing member (6) was a polyethylene terephthalate resin film having a thickness of 125 μm on which an acrylic based resin layer having a thickness of 30 μm was laminated. The acrylic based layer had V-shaped grooves with a pitch of 50 μm, and each groove had a cross section of an isosceles triangle having a vertex angle of 90° and a height (H) of 25 μm. The embossing member was located around the metal rotatable roll (7) such that the V-shaped grooves are perpendicular to the extrusion direction of the continuous resin sheet material (4). The surface profile of the embossing member (6) was accurately transferred to the resin sheet material (1) so that it had a surface profile which complementarily corresponded to the surface profile of the embossing member (6). Further, the V-shaped grooves of the organic material film had forms which were substantially the same those before starting the production.

As the first roll (51), a mirror finished metal roll was used at a temperature of 95° C. which had a diameter of 200 mm. As the rotatable roll (7), a mirror finished metal roll was used at a temperature of 89° C. which had a diameter of 200 mm. As the second roll (52), a mirror finished metal roll was used at a temperature of 112° C. which had a diameter of 200 mm. The produced embossed resin sheet material (1) had a multilayer structure having a total thickness of 1.5 mm in which the surface layer having a thickness of 0.05 mm was laminated on each side of the intermediate layer having a thickness of 1.4 mm.

[Estimation of Embossed Resin Sheet Material]

The produced embossed resin sheet material (1) was cut and its cut surface was mirror finished. Thus prepared cut surface was observed with a super focal depth profile measuring microscope (“VK-8500” manufactured by Keyence Corporation), and a depth (N) of a prism of the groove which was transferred to the embossed surface was measured. Based on such depth and a depth (H) of a prism of the groove of the embossing member, a transfer ratio (β) was obtained according to the following equation (1):

β=(N/H)*100(%) (1)

The transfer ratio was 98%. Further, the surface of the embossed resin sheet material (1) had no defective appearance due to a stripe pattern (so-called a tack mark) formed upon peeling-off from the embossing member tack mark. The results are shown in Table 1 below.

### Comparative Example 1

The above described Example was repeated except that a cylinder of an electroformed nickel plate fitted around the rotatable roll (7) was used as the embossing member (6) in place of the organic material film. The production speed of the embossed resin sheet material (1) was 0.66 m/min. It is noted that the electroformed nickel plate (6) had V-shaped grooves with a pitch of 50 μm, and each groove had a cross section of an isosceles triangle having a vertex angle of 90° and a height (H) of 25 μm. The nickel plate was located around the metal rotatable roll (7) such that the V-shaped grooves are perpendicular to the extrusion direction of the continuous resin sheet material. The transfer ratio (β) of the produced embossed resin sheet member was 62%, and a lot of tack marks were observed on the surface of the sheet material.

Then, when a supply rate of the resin (2) and the rotating speeds of the first press roll (51), the second press roll and the rotatable roll (7) were adjusted so as to achieve an embossed resin sheet material production speed of 0.58 m/min., and the transfer ratio (β) of the produced embossed sheet member was 76%, and a lot of tack marks were observed on the surface of the sheet material.

Further, when the embossed resin sheet material production speed was adjusted to 0.41 m/min., the transfer ratio (β) of the produced embossed sheet member was 98%, and a few tack marks were observed on the surface of the sheet material.

The results of Comparative Example 1 are shown together with those of Example 1 in the Table 1 below:

TABLE 1

| | production | transfer | |
|---|---|---|---|
| | speed | ratio (β) | |
| | (m/min.) | (%) | tack mark |
| Example 1 | 0.68 | 98 | not observed |
| Comparative | 0.66 | 62 | many |
| Example 1 | 0.58 | 76 | many |
| | 0.41 | 98 | a few |

What is claimed is:

1. A process for the production of an embossed sheet material comprising the steps of:
providing a continuous resin sheet material by extruding a molten resin through a die, and
transferring a surface profile of an embossing member by pressing the continuous resin sheet material between a press roll and the embossing member
wherein the embossing member is made of an organic material.

2. An apparatus for the production of an embossed sheet material comprising
a die which provides with a continuous resin sheet material by extruding a molten resin, and
an embossing member of which surface profile is to be transferred to the continuous resin sheet material,
wherein the embossing member is made of an organic material.
